(19) United States
(12) Patent Application Publication
(10) Pub. No.: US 2011/0186739 A1
(43) Pub. Date: Aug. 4, 2011

(54) MOBILE TOMOGRAPHIC CARGO INSPECTION SYSTEM

(75) Inventors: Andrew D. Foland, Wellesley, MA (US); Richard Franklin Eilbert, Lincoln, MA (US); Michael R. Gambini, Bolton, MA (US); Nicholas Danvers Penrose Gillett, Redondo Beach, CA (US); Ronald S. McNabb, Charlestown, MA (US); Boris Oreper, Newton, MA (US); David Perticone, Winchester, MA (US); Vitaliy Ziskin, Brighton, MA (US)

(73) Assignee: L-3 Communications Security and Detection Systems Inc., Woburn, MA (US)

(21) Appl. No.: 13/021,194

(22) Filed: Feb. 4, 2011

Related U.S. Application Data
(60) Provisional application No. 61/301,485, filed on Feb. 4, 2010.

(51) Int. Cl. G01N 23/04

(52) U.S. Cl. 250/360.1; 378/19

(57) ABSTRACT

Apparatus for scanning large cargo to detect concealed contents include a mobile platform configured to carry and position at least one X-ray or gamma-ray source and at least one detector array at a plurality of positions with respect to a stationary cargo. The detector array may be mounted on a boom moveably affixed to the mobile platform. Multiple measurements of radiation passing through the cargo for various source-detector orientations can be used to compute volumetric images of concealed content within the cargo.

### CROSS-REFERENCE TO RELATED U.S. APPLICATIONS

The present application claims the benefit of U.S. provisional patent application No. 61/301,485 filed on Feb. 4, 2010, which is incorporated herein by reference.

### BACKGROUND

Inspection systems are used to provide security at shipping terminals and other locations through which cargo passes. Numerous cargo containers may pass through these points and weapons, explosives or other contraband may be concealed within any one of the cargo containers, making it difficult to open every container and inspect its contents. Inspection systems are used to detect these contraband items without opening the cargo containers. Frequently, inspection systems use penetrating radiation, such as x-rays, to form an image of an item under inspection. By measuring the radiation after it has interacted with an item under inspection, an image of the item may be formed.

For inspecting cargo containers, which are typically very large, an x-ray source may be mounted to a truck. The truck may have a boom with a detector array at the end. When the truck is positioned next to a cargo container, the boom can be extended over the cargo container to position the detector array so that radiation from a source on the truck can be detected after passing through the container.

For cargo containers that are larger than the detector array, the truck may be moved relative to the cargo container to form an image of different pieces of the cargo container at different times. These image pieces can then be assembled into a composite image of the cargo container that can be analyzed to detect contraband.

Images formed in this fashion are sometimes called two-dimensional projection images. A projection image is formed by passing radiation through an item under inspection. The radiation is measured with detectors in a two-dimensional array. Because attenuation of the radiation is related to the average density of the material through which the radiation passed, the magnitude of the measured radiation represents the density of material along a ray from the x-ray source to an x-ray detector used to make the measurement. Each such measurement represents a data point, or “pixel,” in the projection image.

Making projection x-ray images in this fashion is useful to detect many types of contraband. Contraband objects may appear in the image as a group of pixels having an attenuation different than that of other surrounding pixels. The group will form a region with an outline conforming to the silhouette of the object. Such a group of pixels may be identified as a “suspicious region” based on manual or automated processing if it has a shape and size that matches a contraband item. Densities, or other measured material properties, of the pixels in the group also may be used in the processing to identify suspicious regions.

If no suspicious region is detected in an image of an item under inspection, the item may be “cleared” and allowed to pass the checkpoint. However, if a suspicious region is found in the image, the item may be “alarmed.” Processing of an item in response to an alarm may depend on the purpose of the inspection. For example, an alarmed item may be inspected further, destroyed, blocked from passing the checkpoint, or processed in any other suitable way.

For inspection of smaller items, such as suitcases or hand-carried luggage, other types of inspection systems have been used. Such systems are constructed to inspect items up to about 1 meter in any dimension. An MVT™ imaging system is sold by L-3 Communications Security and Detection Systems, Inc., of Woburn, Mass. The MVT™ system employs multiple source-detector pairs. Each pair is positioned to form a projection image of an item under inspection from a different angle. The images from different angles are analyzed to detect suspicious regions within an item under inspection.

Although inspection of smaller items can be carried out readily with systems like the MVT™ imaging system, inspection of items larger than about 1 meter in any dimension is difficult. For example, various types of cargo transported by ships, trains, and trucks may be too large to be placed on a conveyor or in an apparatus for scanning and imaging.

Computed tomography (CT) is another imaging method that is used in medical or security inspection applications. In a CT scanner, attenuation through an item or subject under inspection is measured from multiple different directions. Typically, these measurements are made by placing the x-ray source and detectors on a rotating gantry. An item under inspection passes through an opening in the center of the gantry. As the gantry rotates around the item, measurements are made on rays of radiation passing through the item from many different directions. These measurements can be used to compute density, or other material property, of the item under inspection at multiple points throughout a plane through which the rays pass. Each of these computed densities represents one data value of the image, frequently called a “voxel,” in a slice through the item. By moving an item under inspection through the opening in the gantry and collecting image data at multiple locations, voxels having values representative of multiple slices through the item may be collected. The voxels can be assembled into a three dimensional, or volumetric, image of the item under inspection.

CT imaging is sometimes desirable because some objects are more reliably detected in volumetric images formed by the CT scanner rather than in projection images. However, CT scanning of large items would require large moving parts that would be problematic to construct. CT systems have a tunnel that passes through the rotating gantry. A conveyer moves items under inspection through the tunnel. Such systems have traditionally had tunnel sizes of less than 1 m. In contrast, a cargo container may be more than 10 feet on a side.

### SUMMARY

The inventors have conceived of apparatus and methods for scanning large items containing concealed contents and computing volumetric images of at least portions of the items to reveal information about the concealed contents. The large items may comprise cargo that is packaged in large containers measuring more than about 1 meter in any dimension. The apparatus and methods may be used to inspect cargo for purposes of security, e.g., detecting the presence of contraband or potentially harmful materials.

In one aspect the invention may be embodied as a cargo inspection system comprising a mobile platform supporting at least one penetrating radiation source, such as an X-ray or gamma-ray source, and at least one boom attached to the mobile platform. At least one detector for detecting the penetrating radiation may be attached to the at least one boom. The at least one boom and mobile platform may be adapted to position the at least one detector to detect the penetrating radiation that passes through at least one portion of cargo in more than one direction. There may be sensing apparatus for determining directions of rays from the radiation source passing through the cargo and detected by the at least one detector. The cargo may be large (e.g., measuring more than 1 meter in any direction) and may contain concealed items. The at least one detector may comprise one or more detector arrays that may be linear arrays or two-dimensional planar arrays. In some embodiments, the at least one boom may be configured to move the at least one detector to a plurality of positions with respect to the mobile platform for detecting the radiation.

In another aspect, the inspection system may be embodied as a system comprising a mobile platform, at least one detector, and at least one radiation source, as described above. The inspection system may further comprise one or a plurality of booms configured to position a plurality of detectors in fixed positions with respect to the mobile platform for detecting the penetrating radiation that passes through the cargo.

The radiation source or sources, boom or booms, and detectors may be mounted on or attached to a mobile platform, such as a truck, tractor, utility vehicle, or any other mobile vehicle designed or configured to carry the radiation source(s), boom(s), and detectors.

In another aspect, the invention may be embodied as a method of operating a system for scanning or inspecting cargo. The method may comprise emitting penetrating radiation, such as X-ray or gamma-ray radiation, from at least one source on a mobile platform, and positioning at least one detector connected to at least one boom attached to the mobile platform to receive the penetrating radiation. The method may further comprise moving the boom and/or mobile platform with respect to the cargo, and detecting signals representative of radiation that passes through at least one portion of the cargo in more than one direction. In some embodiments, the at least one boom may comprise a single moveable boom, and the method may comprise obtaining data representative of the detected radiation as a boom moves, such as by swinging, with respect to the mobile platform. In other embodiments, the at least one boom may comprise one or a plurality of booms configured to position a plurality of detectors in substantially fixed positions with respect to the mobile platform, and the method may comprise obtaining data representative of the detected radiation as the mobile platform moves with respect to the cargo. Motion of a boom, radiation source, and/or motion of a mobile platform may be used to change the direction of ray paths between a radiation source and detectors of a detector array that pass through an item under inspection during a scan of the item under inspection. Data may be obtained while the mobile platform moves past an item under inspection. Though, in some implementations, data may be obtained when the mobile platform is stationary at each of a plurality of discrete locations adjacent to the item.

An embodiment of a method for cargo inspection may include constructing at least one image of at least a portion of the cargo to reveal information about contents concealed within the cargo. Any suitable image construction technique may be used. For example, the image construction may utilize algebraic, iterative, and/or approximation techniques associated with tomographic imaging. The image may be representative of a three dimensional distribution of a material property, such as density, X-ray stopping power, or effective atomic number, within the cargo under inspection. The method may include obtaining data representative of detected penetrating radiation that has passed through at least a portion of the cargo. The data may be provided to and received by at least one data receiving device or at least one processor as the inspection system moves. The at least one image may comprise a volumetric image of at least a portion of the cargo under inspection. In some embodiments, the at least one image may comprise a two-dimensional slice or three dimensional image representative of a distribution of a material within the cargo. The image may comprise a tomographic image of at least a portion of the cargo.

In some embodiments, the entire volume of an item under inspection may be constructed. Though, in other embodiments, only a portion of the cargo may be constructed, i.e., the construction may be truncated. In embodiments in which an image of only a portion of the cargo is constructed, the portion constructed may be a 3-d region of interest chosen based on a previous scan by the system. In this regard, a portion of cargo, rather than an entire volume of the cargo, may be scanned in some embodiments. The portion of the cargo scanned may be based on a previous scan, e.g., a previous scan may identify a portion of interest to be subsequently scanned for further analysis.

The foregoing is a non-limiting summary of the invention.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a sketch of a cargo inspection system according to some exemplary embodiments of the invention;

FIG. 2 is a sketch illustrating the formation of a volumetric image from measurements of attenuation along multiple rays passing through an item under inspection from different directions;

FIG. 3 is a schematic illustration of the cargo inspection system of FIG. 1;

FIGS. 4A and 4B are sketches illustrating aspects of the inspection system of FIG. 1 at different times during inspection of a cargo container;

FIG. 5 is a sketch of a cargo inspection system according to an alternative exemplary embodiment of the invention;

FIG. 6 is a schematic illustrating positions of the cargo inspection system using a swinging boom at multiple times during inspection of a cargo container;

FIG. 7 is a schematic illustration of positions of components of the cargo inspection system having multiple fixed booms at multiple times during inspection of a container of cargo;

FIG. 8A is a flow chart of a method of operating of a cargo inspection system of the type illustrated in FIG. 1; and

FIG. 8B is a flowchart of a method of operation of a cargo inspection system of the type illustrated in FIG. 5.

### DETAILED DESCRIPTION

The inventors have recognized and appreciated that an improved cargo inspection system may be provided by adapting a cargo inspection system to form three-dimensional volumetric images of cargo containers. Such an improved system may be constructed with the aid of components and techniques used for manufacturing boom trucks. However, rather than functioning simply to position a detector array near a cargo container, these components may be adapted to measure radiation passing through a cargo container under inspection from numerous directions. These measurements may then be processed to construct a volumetric image of an item under inspection, such as a cargo container. Such a system may be implemented in one embodiment by constructing a mobile platform with an attached moveable boom that can move at least one detector relative to the mobile platform as radiation measurements are being made. Alternatively or additionally, a mobile platform may be adapted to position multiple detector arrays near a cargo container.

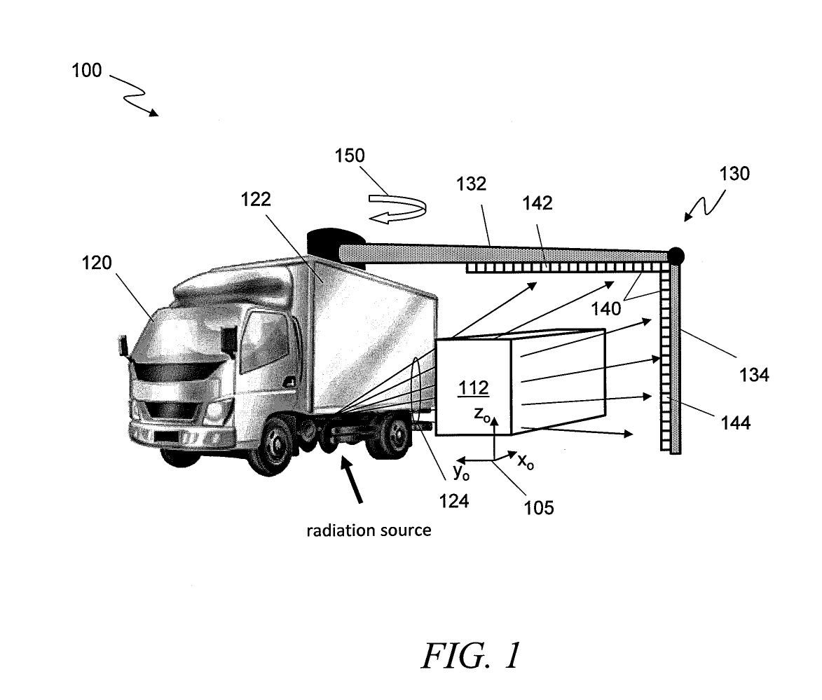

FIG. 1 is a sketch of an exemplary embodiment of a cargo inspection system adapted to form a three-dimensional volumetric image of an item under inspection, here illustrated as a cargo container 112. As is known in the art, a cargo container may have dimensions that are substantially larger than 1 meter. For example, a container may have a shortest side that is in excess of 5 feet. Many cargo containers may have a shortest side that is in excess of 8 feet. System 100 can form volumetric images of such large cargo containers.

The system 100 includes a mobile platform 120, here illustrated as a truck. Mobile platform 120 holds one or more radiation sources (not visible in FIG. 1). The sources may be positioned within mobile platform 120 to emit a beam 124 of radiation through a side 122 of mobile platform 120. For forming an image of cargo container 112, mobile platform 120 may be positioned with side 122 adjacent cargo container 112. In some embodiments, the radiation source or sources may be affixed to the mobile platform in any suitable manner and configured to emit at least one beam of radiation away from the mobile platform and through cargo. In some embodiments, one or more radiation sources may be mounted on apparatus to lower and raise the source(s) with respect to a ground level. Accordingly, measurements may be obtained with the source located at different elevational positions.

Mobile platform 120 may be configured with at least one boom 130. In the configuration illustrated in FIG. 1, a single boom 130 is extended. Boom 130 may be constructed using known techniques for forming a boom. In this example, boom 130 is shown to have at least two segments, horizontal segment 132 and vertical segment 134. In operation, the segments 132 and 134 may be positioned at approximately a right angle. However, boom 130 may be articulated in one or more locations such that boom 130 may be collapsed or extended with segments positioned at relative angles other than 90 degrees. One of skill in the art will recognize that affixing a moveable boom to a mobile platform, as illustrated in FIG. 1, may be achieved with the aid of manufacturing techniques and components developed for the manufacture of trucks or vehicles having booms.

In the embodiment illustrated, a detector array 140 is mounted on boom 130. In this example, detector array 140 is an L-shaped array, having detector array segments 142 and 144. Though, the invention is not so limited and array 140 may have a curved or arced shape, or shaped as a portion of a polygon, in other embodiments. Each of the array segments 142 and 144 may contain multiple detector elements (e.g., linear arrays of detectors), each measuring radiation emitted by the radiation source on mobile platform 120. Though, detector array 140 may have any suitable configuration. As an example, each of the detector array segments 142 and 144 may be a two-dimensional array, containing multiple rows of detector elements. Regardless of the configuration of detector array 140, a detector array such as detector array 140 may be constructed with the aid of techniques and components developed for X-ray or gamma-ray detection.

In operation, detector array 140 may be positioned so that it is illuminated by radiation beam 124 that may penetrate and pass through cargo 112. In the embodiment illustrated, beam 124 is a fan beam. Beam 124 has a beam width sufficiently wide to illuminate detector array segments 142 and 144 when boom 130 is extended, as illustrated in FIG. 1. Such a beam may be formed in any suitable way. For example, the source may include a collimator that shapes radiation emitted from the source into the beam configuration illustrated. Though, it is not a requirement that the full extent of detector array 140 be simultaneously illuminated. In some embodiments, the source within mobile platform 120 may be a scanning source that emits radiation towards only a portion of detector array 140 at any given time but moves through the angle covered by beam 124 such that the entirety of detector array 140 is illuminated.

In embodiments in which multiple sources are included in mobile platform 120, the sources may be time multiplexed. Collection of data from detector array 140 also may be time multiplexed such that data is collected with based on radiation from each of the sources. Multiple sources, for example, may emit radiation at different energies or other characteristics and/or may be spatially separated to emit radiation from different directions.

Beam 124 may contain penetrating radiation of any suitable energy level. The radiation may be in the x-ray or gamma-ray spectrum, for example. Beam 124 may be a single energy beam. Though, beam 124 may contain multiple energies to support dual energy measurement techniques. Regardless of the energy or energies contained in beam 124, detector array 140 may contain detector elements that can measure radiation at that energy. The detector elements may be adapted to measure a radiation at a single energy or at multiple energies, and the specific construction of both the source and the detector elements may depend on a material property to be measured by system 100.

Regardless of the nature of the source emitting beam 124, radiation from that source passes through cargo container 112. The radiation, after it has been attenuated by cargo container 112, is detected at detector array 140. Each detector element in the detector array 140 provides an output signal indicating intensity of radiation received at a location on detector array 140. Measurements of the outputs of the detectors in detector array 140 made with boom 130 in the position illustrated in FIG. 1 could be used to form a projection image through cargo container 112. However, the system of FIG. 1 is adapted to form a volumetric image of an item under inspection, such as cargo container 112.

The cargo inspection system of FIG. 1 is configured to measure X-ray or gamma-ray radiation passing through cargo container 112 from multiple directions such that sufficient data may be collected to construct a volumetric image. In the embodiment illustrated, boom 130 may be mounted to mobile platform 120 with a mounting that allows relative motion between detector array 140 and mobile platform 120. During a scan of an item under inspection, the system may collect data, representing the measured radiation at detector array 140 with different relative positions of detector array 140 and radiation source or mobile platform 120.

Additionally, the system may collect data representing the output of the detectors in detector array 140 with mobile platform 120 in different positions relative to cargo container 112. Collectively, these measurements provide information about the attenuation of radiation passing through cargo container 112 from numerous directions and can be used for constructing a volumetric image of cargo container 112. In some embodiments, motion of mobile platform 120 during a scan or inspection of cargo may be automated and monitored or measured, and positions of the one or more radiation sources and detectors with respect to the cargo may be calculated from data obtained from the monitoring or measuring.

In this regard, the inspection system 100 may include motion control apparatus and sensors for positioning the detectors 140 and mobile platform 120 with respect to cargo 112, and providing position data for determining the positions of at least one radiation source and each one of the detectors in the detector array 140 with respect to the cargo. By determining source and detector locations, the direction or path of rays through the cargo can be calculated, and the voxels identified that affect the rays as they pass through the cargo. In some embodiments, a stationary coordinate frame 105, constructed numerically for data processing, may be chosen as a reference coordinate frame to which locations of the radiation source(s), mobile platform, and detectors are referenced.

As used herein, “an image” refers to a collection of data, displayed or not displayed, that represents physical characteristics of at least one item under inspection. For example, an image may be data representing density at numerous points throughout an item under inspection. In some inspection systems, the density image is presented visually to a human operator. However, a computerized system may be used to automatically process the image to identify a density profile that is characteristic of a contraband object. Accordingly, it is not a requirement that an “image” be displayed in visual form. Though, in many instances, images are displayed in visual form by mapping colors or intensities to the data values representing densities and creating a display with color or intensity determined from the image data.

It should be appreciated that, though density is used as a specific example of a material property to be determined, inspection systems are not limited to forming images based on density. Any measurable material property may be used to form an image instead of or in addition to density. For example, multienergy x-ray inspection systems may measure an effective atomic number of regions within an item under inspection and may form images based on the effective atomic number measurements.

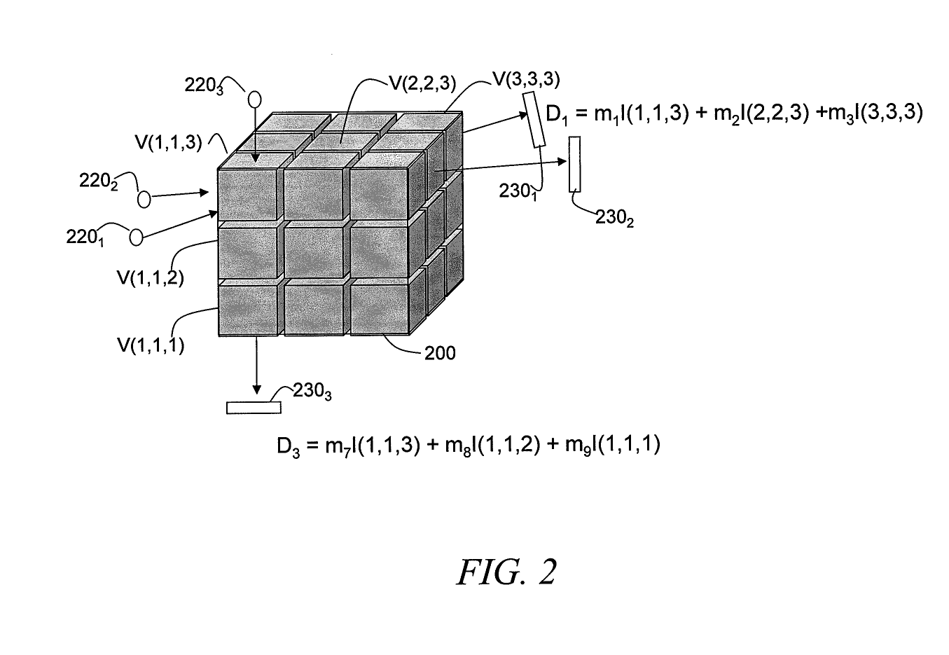

An image, representing cargo container 112, may be constructed from the measured signal outputs of the detector array representing the detected intensity of radiation with boom 130 in different positions relative to mobile platform 120 and to mobile platform 120 in different positions relative to cargo container 112. Construction of the image may be based on computations performed on that data. FIG. 2 is a sketch demonstrating computation of a volumetric image from measurements made on an item under inspection 200, which may be a cargo container 112. In the simple example of FIG. 2, the item under inspection 200 is divided into nine regions. An image of item under inspection 200 is formed by computing a property of the material in each of these nine regions. Each of the nine regions will correspond to a voxel in the computed image. For this reason the regions in the item under inspection are sometimes also referred to as “voxels.”

In the simple example of FIG. 2, item under inspection 200 is divided into nine voxels, of which V(1,1,1), V(1,1,2), V(1,1,3), V(2,2,3) and V(3,3,3) are identified in the drawing. To form an image of item under inspection 200, a material property is computed for each of the voxels from the measured outputs of detectors, of which detectors 230₁, 230₂ and 230₃ are shown. In the illustrated embodiment, the material property is an average density of the material within the voxel.

Measurements from which density may be computed are made by passing rays of radiation through item under inspection 200 from different directions. By measuring the intensity of the rays after they have passed through the item under inspection and comparing the measured intensity to an incident intensity, attenuation along the path of the ray may be determined. If attenuation along a sufficient number of rays traveling in a sufficient number of directions is measured, the data collected can be processed to compute the density within each of the voxels individually. In the embodiment of FIG. 1, each of the rays may represent radiation emanating from a source within mobile platform 120 and striking a detector of detector array 140 with mobile platform 120 and boom 130 each in a specific location. Each output of a detector with either mobile platform 120 or boom 130 in a different position may generate data representing a ray as illustrated in FIG. 2.

Processing may be performed by treating each measurement as defining one equation of a system of simultaneous equations in which the densities of the voxels are unknowns. Computing the image involves solving the system of simultaneous equations for the unknown values of the voxel densities.

For example, FIG. 2 shows a source 220₁ and a detector 230₁. A ray traveling from source 220₁ to detector 230₁ passes through voxels V(1,1,3), V(2,2,3) and V(3,3,3). As a result, the value measured at detector 230₁ will depend on the densities in each of those voxels. The measurement taken at detector 230₁ of a ray from source 220₁ may be expressed as an equation:

D₁=m₁I(1,1,3)+m₂I(2,2,3)+m₃I(3,3,3). (1)

In this equation, I(1,1,3) may be representative of the density within voxel (1,1,3). Similarly, each of the other values express as a function of I( ) may be representative of the density in a corresponding voxel.

Each of the quantities m₁, m₂ and m₃ may represent a weighting factor indicating, for example, an amount that the corresponding voxel influences the value measured at detector 230₁. Each weighting factor may represent many parameters of the inspection system. For example, for voxels that fall along a ray between source 220₁ and 230₁ that leaves source 220₁ at an angle in which source 220₁ emits a relatively low amount of radiation, the weighting factors may be relatively small such that the quantity D₁ has an appropriately small value. Another parameter that may be reflected in a weighting factor is the percentage of the path between 220₁ and detector 230₁ occupied by a corresponding voxel. For example, if a ray between source 220₁ and detector 230₁ passes through all of voxel V(1,1,3) but only through a corner of voxel V(2,2,3), the density of voxel V(1,1,3) will have a greater impact on the value measured by detector 230₁ than the density of voxel (V2,2,3). To reflect this difference in impact, the weighting factor m₁ can be altered, e.g., made larger than the weighting factor m₂. The weighting factors mₙ may also reflect geometric effects, e.g., effects due to different incidence angles of rays on the voxels. In some cases the weighting factors may be calculated a priori.

As shown, a ray from source 220₁ to detector 230₁ represents just one of the rays passing through item under inspection 200. Other rays are shown in the example of FIG. 2. For example, a ray is shown passing from source 220₂ to detector 230₂. As with the ray passing from source 220₁ to detector 230₁, an equation can be written representing the output D₂ measured at detector 230₂. In this case, the ray from source 220₂ to detector 230₂ passes through voxels V(1,1,3), V(2,2,3) and V(3,2,3). Accordingly, the equation for D₂ is given by:

D₂=m₄I(1,1,3)+m₅I(2,2,3)+m₆I(3,2,3). (2)

The equation for the output D₂ of detector 230₂ is in the same form as the equation for D₁. However, the equation expresses a relationship between density values for different voxels and different weighting factors than used to describe the measured output D₁. In the equation describing the output of detector 230₂, values representing voxels V(1,1,3), V(2,2,3) and V(3,2,3) are used. Weighting factors m₄, m₅ and m₆ appear.

A similar equation can be written representing the output of detector 230₃. In the illustrated embodiment, the output of detector 230₃ represents the amount that a ray passing from source 220₃ to detector 230₃ is influenced by the densities of the voxels along that ray and weighting factors representative of parameters of the inspection system. Such an equation, though in the same form as equations for D₁ and D₂, will include values for different voxels and will contain other weighting factors.

FIG. 2 shows only three rays passing through item under inspection 200 for instructional purposes. Each of the rays generates one equation containing as unknowns values representative of the densities of voxels in item under inspection 200. From basic linear algebra, it is known that a system of equations may be solved if the number of linearly independent equations equals or exceeds the number of unknowns. In the simple problem illustrated in FIG. 2, item under inspection 200 is divided into 27 voxels. Accordingly, at least 27 independent equations are required to solve for the density in each of the 27 voxels in the simple example of FIG. 2. For the example of FIG. 2, a volumetric image of item under inspection 200 could be computed using measurements from at least 27 rays passing through item under inspection 200 from different angles. More measurements may be made and used, for example, to improve an image quality. Though, it should be appreciated that techniques are known for approximating a solution if there are more or less than the required minimum number of measurements. Although FIG. 2 shows only a few rays passing through item under inspection 200, in practice hundreds or thousands or more measurements may be taken of rays passing through an item under inspection.

If a sufficient number of measurements along rays from a sufficient number of independent angles are made, the measured outputs of the detectors may be used to define a system of simultaneous equations that may be solved for the unknown values representing the densities of the individual voxels in item under inspection 200. Such a system of simultaneous equations may be represented by a matrix equation in the form:

M*I=D (3)

In this equation, I represents a vector containing the unknown values of the densities of the voxels, which is computed to form an image of item under inspection 200. In the example of FIG. 2 in which 27 voxels are shown, the vector I will have 27 entries. However, FIG. 2 represents a simplified example and, in a practical system, the vector I may have many more than 27 entries.

The value M is a matrix representing the collection of the weighting factors m₁, m₂ . . . . Because the values of the weighting factors are determined by parameters of the system, such as the position and operating characteristics of the source and detector used to take each of the measurements, these values may be determined using separate calculations and/or measurements. For example, the values in the matrix M may be computed from properties of inspection system 110 or may be determined empirically. As one example, the weighting factors may be determined empirically, for example, by taking measurements using the system with an item of known properties between the source and detector.

The quantity D represents a vector containing the measurements made on the rays after they pass through item under inspection 200. The value of D can be determined from measurements obtained during a scan of item under inspection 200.

To compute the image, I, equation (3) above may be solved. Conceptually, I may be computed by multiplying both sides of the equation by the inverse of matrix M. This operation is represented by the equation:

I=M⁻¹*D (4)

For an inspection system, this equation indicates that the image, I, of item under inspection 200 may be computed by multiplying a vector containing measured outputs of multiple detectors by the inverse of a matrix M containing values characterizing the measurement system.

In a physical system, the number of measurements taken will likely exceed the number of voxels in the image. Uncertainty or other variations in the measurement process may prevent a single solution from satisfying simultaneously all equations in a system of equations formed from the measurements. Thus, solving the system of equations formed from actual measurements would involve finding the values that best solve the equations. Techniques are known for solving such a system of equations. These techniques may be algebraic or iterated. Though, any suitable technique may be used.

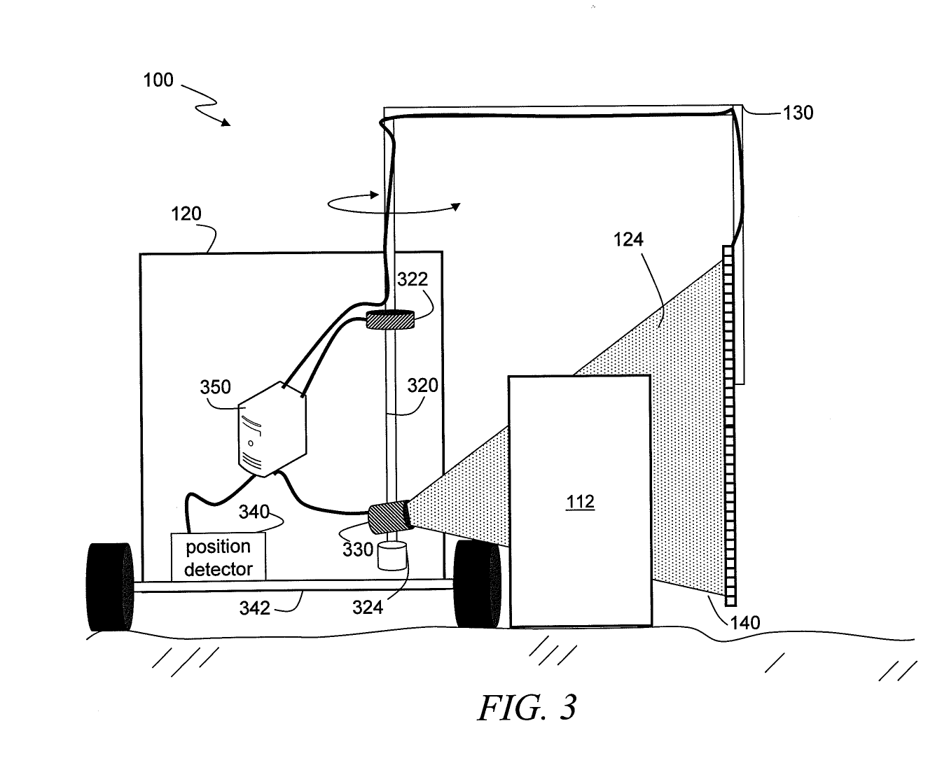

FIG. 3 illustrates schematically components of system 100 and further illustrates how the system may be used to make a sufficient number of measurements to illustrated as a computerized device 350. Computerized device 350 may contain one or more processors. The processors may be programmed to perform image construction using a technique as described above or any other suitable technique. Computerized device 350 may include signal capture components adapted to receive data inputs from multiple sources. As illustrated, detector array 140 is coupled to computerized device 350 such that the signals output from the detectors in detector array 140 may be received and processed within computerized device 350.

Computerized device 350 may receive one or more data inputs that allow the outputs of detector array 140 to be related to particular rays or illumination paths passing through particular voxels of an item under inspection. Such data inputs, for example, may provide information about the relative position of array 140 to mobile platform 120, and/or to source 330. In some embodiments, the relative position may be indicated based on a degree of rotation of boom 130 about shaft 320. Accordingly, FIG. 3 illustrates that a shaft encoder 322 may be included to sense a rotation of shaft 320. The shaft encoder may be a known device and may provide an output that is coupled to computing device 350 that indicates the rotation of shaft 320, from which an orientation and/or position of boom 130 and/or detector array 140 can be computed. Though, it should be appreciated that shaft encoder 322 is an example of a component that provides information indicating relative position of detector array 140 and mobile platform 120, but any suitable position or orientation measurement or sensing mechanism may be used.

As described above, radiation measurements may be made as mobile platform 120 moves relative to cargo container 112. Relative motion of mobile platform 120 may be determined in any suitable way. As one example, rotation of axle 342 on mobile platform 120 may provide an indication of motion of mobile platform 120. Accordingly, the example of FIG. 3 illustrates a position detector 340 coupled to axle 342. Position detector 340 may output a signal indicating an amount of rotation of axle 342 and therefore providing information to determine the motion and/or position of mobile platform 120. The motion or position of the mobile platform with respect to the cargo can be used to determine locations of the source(s) and detectors with respect to the cargo. Though, it should be appreciated that any suitable mechanism may be used to determine the position of the source and detector array relative to an item under inspection, including, for example, video imaging of the inspection area, laser sensing or construct a volumetric image of cargo container 112. FIG. 3 illustrates a radiation source 330 located within mobile platform 120. As illustrated, source 330 is positioned to irradiate detector array 140 attached to boom 130.

Boom 130 may be mounted so that it can swing relative to mobile platform 120. This swinging motion can be provided by rotation about an axis through mobile platform 120. In the schematic illustration of FIG. 3, the swinging motion of boom 130 is provided by rotation of a supporting shaft 320. Though in some implementations, boom 130 may be affixed to a turret that provides rotation and movement of the boom. Shaft 320 may be driven in any suitable way. For example, shaft 320 may be driven by motor 324 or any suitable motion control apparatus. As can be appreciated, rotation or movement of boom 130 can cause horizontal movement of detector array 140 with respect to the mobile platform, e.g., a fore-aft or side-side motion of the detectors with respect to the mobile platform 120.

In some embodiments, the direction of radiation beam 124 (FIGS. 1 and 3) may change as boom 130 swings to ensure that radiation from source 330 is directed towards detector array 140, regardless of the position or orientation of detector array 140. The direction of a beam 124 emitted from source 330 may be changed in any suitable way. For example, electronic beam steering techniques may be employed. However, in the embodiment illustrated in FIG. 3, mechanical motion of source 330 is used to change the direction of beam 124.

Any suitable mechanism may be used to synchronize motion of beam 124 with motion of detector array 140 on boom 130. In the embodiment illustrated in FIG. 3, that synchronization is achieved by a mechanical coupling between source 330 and boom 130. For example, source 330 may be mounted to shaft 320, which rotates to move boom 130. However, other mechanisms for synchronization may be employed. As an example of one alternative, source 330 may be driven by a motor controlled by a control system synchronized with the control system of motor 324. In some implementations, a motion control system may control and synchronize motion of the detectors and radiation source(s).

FIG. 3 also illustrates that system 100 includes components for data collection and processing. In this embodiment, components for data collection and processing are measurement of the cargo position with respect to the mobile platform, tagging the cargo with a device that provides location information or can be used to obtain location information, etc.

In addition to being programmed to capture data relating to radiation measurements and positions, computerized device 350 may be programmed to generate control signals. Computerized device 350 may control motor 324 or other components that cause motion of mobile platform 120 and/or boom 130. Computerized device 350 may also control elements of operation of one or more radiation sources, such as timing at which or direction in which they emit radiation.

Regardless of the manner in which position detector 340 determines the position of mobile platform 120, the output of position detector 340 may be coupled to computing device 350. Computing device 350 may receive these or other values from which it can determine the orientation of rays, relative to a frame of reference containing cargo container 112, striking detector array 140 at any time. This information may be used for constructing a volumetric image of cargo container 112. Once a volumetric image is constructed, it may be processed, either through automated analysis or by manual inspection, to detect contraband within cargo container 112.

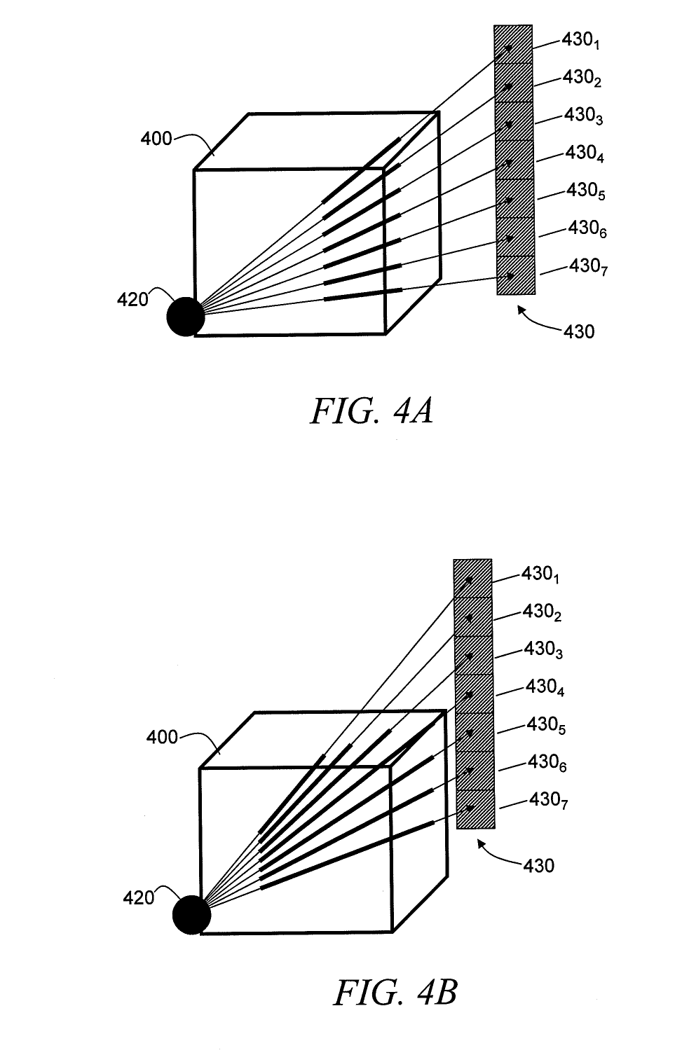

FIGS. 4A and 4B illustrate, in perspective views, an embodiment in which swinging of boom 130 (not shown) enables measurements of the attenuation of radiation through an item under inspection 400 along a sufficient number of rays from different directions to construct a volumetric image. FIG. 4A illustrates rays from a source 420 passing through an inspection area 400 with a detector array 430 in a first position according to a first boom orientation. As shown, detector array 430 includes detector elements 430₁ . . . 430₇. Radiation from source 420 to each of the detector elements 430₁ . . . 430₇ represents a ray through inspection area 400. In this simplified example, seven detector elements are illustrated. However, in various embodiments, more than seven detector elements will be present in a detector array.

Regardless of the number of detector elements in the array and the dimension of the array, when array 430 moves into a different position according to a second orientation, as illustrated in FIG. 4B, the rays between source 420 and detector array 430 pass through different regions of inspection area 400. To collect a sufficient number of measurements from a sufficient number of directions to construct a volumetric image, measurements may be made with detector array positioned in more than two locations. In some embodiments, a measurement may be made with detector array positioned in a first location, such as is indicated in FIG. 4A. Boom 130 (FIG. 1) may then move detector array 430 to a different location where a further measurement may be made. However, it is not a requirement that each measurement be made with the detector array stopped in a discrete location. In some embodiments, boom 130 may swing continuously during the scan of an item under inspection. In such an embodiment, data, representing the outputs of the detectors in the detector array attached to boom 140, may be collected to at discrete time intervals. Alternatively, the data output from the detector elements of the detector array may be captured as a continuous stream of data. Regardless of the format of the data output from the detector array, the data output from the detector array at any time may be correlated to a position of the detector array(s) or of each detector in the array(s) using, for example, a shaft encoder 322 and a position detector 340 or any other suitable mechanism to determine the orientation of rays striking the detector array at the time the outputs were produced.

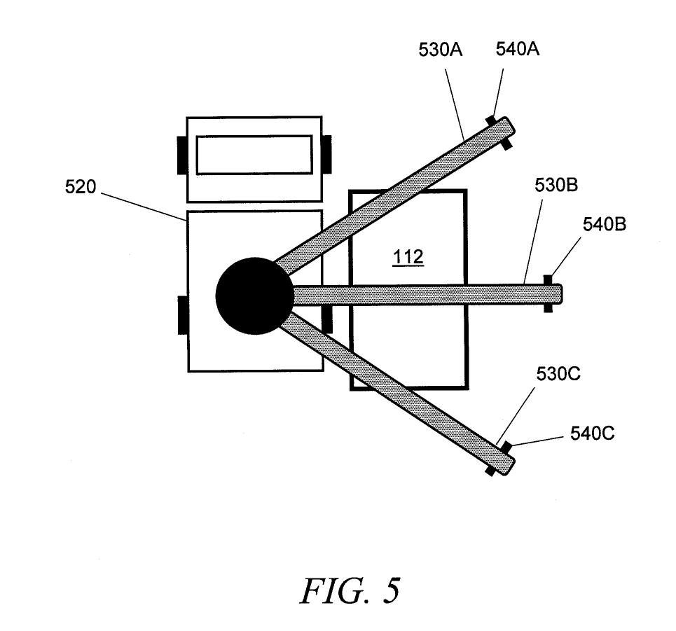

Turning to FIG. 5, an alternative approach for forming measurements through a cargo container 112 is illustrated. In this example, a mobile platform 520, such as a truck is provided with multiple booms. Here, three booms 530A, 530B and 530C are illustrated. Each of the booms is equipped with a detector array, 540A, 540B and 540C, respectively. The booms 530A, 530B and 530C are configured such that when deployed, each positions its respective detector array at a different orientation or position relative to a radiation source (not shown) within mobile platform 520. The outputs of each of the detector arrays 540A, 540B and 540C represents measurements on attenuation of rays passing through cargo container 112 in a different direction. Mobile platform 520 may be equipped with data capture, data processing, and motion control components similar to those included within mobile platform 120 and described above.

Measurement of rays in additional directions could be obtained by rotating one or more of booms 530A, 530B or 530C as boom 130 (FIG. 1) is rotated. However, in one embodiment, each of booms 530A, 530B and 530C may be configured to remain stationary relative to mobile platform 520 when deployed. Nonetheless, measurements from rays in multiple directions may be obtained by moving mobile platform 520 with respect to cargo container 120.

Referring again to FIG. 5, in some embodiments, a motor 324 to rotate shaft 320 may be omitted. Likewise, a position encoder, such as position encoder 322 may be omitted if the positions of booms 530A, 530B and 530C, when deployed, relative to mobile platform 520 are known. Nonetheless, a position detector, such as position detector 340 for determining a position of the truck with respect to the cargo item may be included within mobile platform 520.

In operation, one or more radiation sources (not shown) within mobile platform 520 irradiates detector arrays 540A, 540B and 540C. Radiation from a source may be directed to multiple detector arrays by employing a wide angle source. In some embodiments, a specialized collimator may be used to direct radiation from a source within mobile platform 520 simultaneously at each of the detector arrays. Though, any suitable mechanism may be used for directing radiation for each of the detector arrays 540A, 540B and 540C. In some embodiments, multiple sources may be used. As another example, the beam from a single source may be directed toward different ones of the detector arrays at different times. The directing of a radiation beam may be accomplished using electronic and/or mechanical apparatus to move or aim the source, or may be achieved in any other suitable way, e.g., by deflecting the beam with a beam-deflecting component.

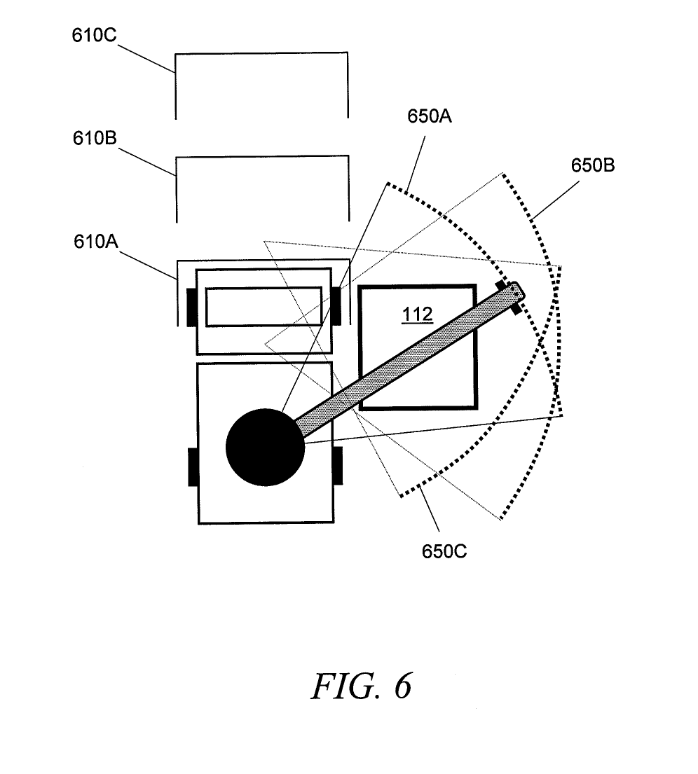

Turning to FIG. 6, operation of a system, as in FIG. 1 is illustrated. FIG. 6 shows mobile platform 120 in multiple different positions. In this example, three positions 610A, 610B and 610C are illustrated, though it should be appreciated that data may be collected with mobile platform 120 in more than three positions. To collect data to construct an image of cargo container 112, mobile platform 120 may be sequentially positioned in each of the positions 610A, 610B and 610C. In each of the positions, mobile platform 120 may be stopped and boom 130 may be rotated through an arc, such as arc 650A associated with position 610A, arc 650B associated with position 610B and arc 650C associated with position 610C. As the boom 130 moves through an arc, the signals output from detectors in the detector array attached to boom 130 may be captured and processed as described above.

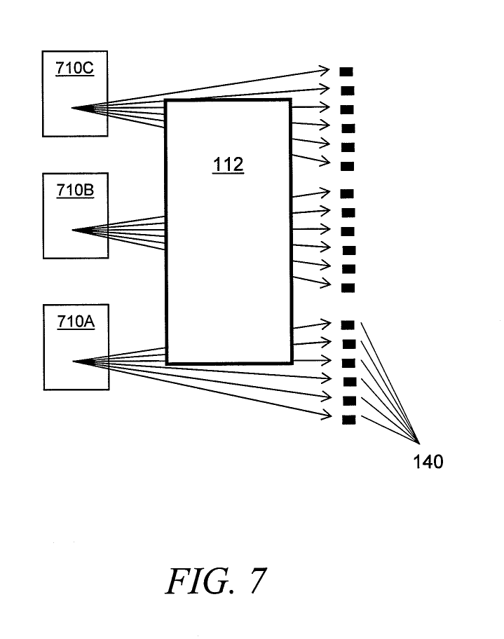

FIG. 7 illustrates operation of a system of the type illustrated in FIG. 5. Though, in this example, the mobile platform is shown equipped with six booms, each having mounted thereto a detector array, all of which may be used to collect data as mobile platform 520 moves. In some embodiments, multiple linear detector arrays or a two-dimensional detector array may be supported by a single boom 130. As depicted in FIG. 7, multiple positions 710A, 710B and 710C of mobile platform 520 are illustrated. In this example, three discrete positions are shown for simplicity of illustration. However, in some embodiments, data may be acquired continuously, meaning that data representing the outputs of the detectors in the detector arrays is captured as mobile platform 520 moves from position 710A, through position 710B to position 710C. As the mobile platform moves from position 710A to position 710C, multiple measurements can be made to collect data sufficient to construct a volumetric image of at least a portion of the cargo container.

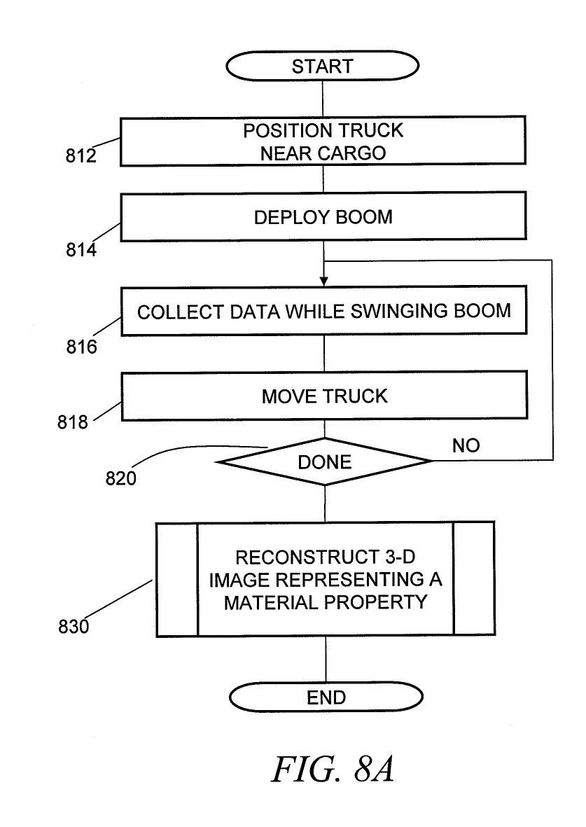

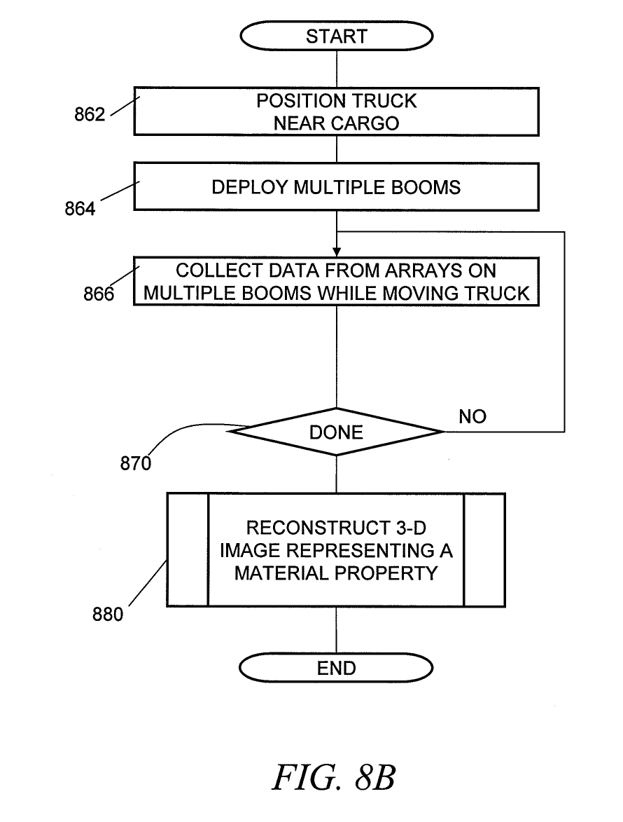

FIG. 8A illustrates a method of operation of an inspection system of the type illustrated in FIG. 1. The method may begin when an item to be inspected is identified. As example, a cargo container may be identified for inspection as it is being removed from a ship. At block 812, a mobile platform 120, such as a truck is positioned near the cargo to be inspected.

At block 814, a boom of the mobile platform may be deployed to position a detector array such that radiation emanating from a source on the mobile platform passes through the cargo to be inspected and is detected by the detector array on the boom. This initial position of the boom and the mobile platform may establish a frame of reference for determining orientation of rays passing through the cargo during a scan. By tracking motion of the mobile platform and/or the boom relative to this initial position, each measurement may be related to a coordinate system fixed with respect to the established frame of reference and that coordinate system may be used to construct a volumetric image, e.g., using computer tomography methods.

The process may then continue to block 816. At block 816 data may be collected while swinging the boom. As described above, the data may be collected while the boom swings or may be collected with the boom swung to each of multiple discrete locations.

Regardless of whether the data is collected at discrete locations or continuously, once a swing of the boom is completed, the mobile platform may be moved to a new location at block 818. From block 818 the process continues to decision block 820. At decision block 820, the process may loop back depending on whether a scan of the item under inspection has been completed. If the scan has not been completed, the process may loop back to block 816 where more data may be collected while swinging the boom. The process may continue in this fashion until sufficient data has been collected at multiple locations of the mobile platform relative to the cargo container to construct a volumetric image. The image may be of the full cargo container or some portion of it that has previously been determined to be of interest. When sufficient data has been collected, the process may branch from decision block 820 to subprocess 830. At subprocess 830, a three-dimensional image representing a material property of the cargo under inspection may be constructed. This subprocess may be implemented by software executing on a computer such as computerized device 350. Though, the processing may be performed in any suitable way. Regardless of where it is performed, once the image has been constructed, it may be analyzed by a human or using computerized data processing to detect contraband or for other inspection purposes.

FIG. 8B illustrates a process of operating an inspection system of the type illustrated in FIG. 5. As with the process of FIG. 8A, the process of FIG. 8B may begin when a cargo container to be inspected is identified. The process may begin at block 862, where a mobile platform 520, such as truck (FIG. 5) is positioned near the cargo. At block 864, multiple booms may be deployed to position detector arrays where they can detect radiation from a source on the mobile platform after it has passed through the cargo under inspection.

The process may then proceed to block 866 where data from the arrays on the multiple booms may be collected while the mobile platform is moving, or collected at a plurality of discrete locations to which the mobile platform is moved.

The process may proceed to decision block 870. At decision block 870, the process may loop back to block 866 to continue collection of data if the scan of the item under inspection is not completed. Conversely, if the scan is completed, the process may branch from decision block 870 to subprocess 880. At subprocess 880, a three-dimensional image may be constructed from the collected data. As with the processing in subprocess 830, the construction in subprocess 880 may generate an image representing any suitable material property, which may then be analyzed to determine whether the cargo container under inspection contains contraband material or otherwise needs to be alarmed.

Having thus described several aspects of at least one embodiment of this invention, it is to be appreciated that various alterations, modifications, and improvements will readily occur to those skilled in the art.

As one example, linear detector arrays are illustrated. However, in some embodiments, panel or two-dimensional arrays may be used instead of or in addition to linear arrays.

As another example, data collection and processing was illustrated as performed in a computing device mounted in a mobile platform. It should be appreciated that any number of computing devices, at any suitable locations, may be used for data processing. Computing devices, for example, may be connected over one or more wired or wireless networks so that data processing and/or image analysis may be performed at any suitable locations.

Such alterations, modifications, and improvements are intended to be part of this disclosure, and are intended to be within the spirit and scope of the invention. Accordingly, the foregoing description and drawings are by way of example only.

The above-described embodiments of the present invention can be implemented in any of numerous ways. For example, the embodiments may be implemented using hardware, software or a combination thereof. When implemented in software, aspects of the invention may be embodied as computer-readable medium comprising encoded instructions that, when executed on at least one processor, cause the at least one processor to execute one or more method steps of an embodiment of the invention. The software code may be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a computer readable medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other non-transitory, tangible computer storage medium) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A system for inspecting cargo comprising:
a mobile platform having a penetrating radiation source;
a first boom coupled to the mobile platform;
a detector for detecting radiation from the radiation source, the detector mounted to the first boom; and
position sensing apparatus for determining directions of rays from the radiation source passing through at least a portion of the cargo and detected by the detector.

2. The system of claim 1, further comprising a processor configured to receive signal data representative of radiation detected by the detector, and wherein the first boom is configured to move the detector to a plurality of positions with respect to the mobile platform for detecting radiation from the radiation source.

3. The system of claim 2, further comprising:
motion control apparatus to position the detector with respect to the cargo, and wherein the sensing apparatus is configured to provide position data for determining positions of the detector and the radiation source with respect to the cargo.

4. The system of claim 3, wherein the motion control apparatus is further configured to direct radiation from the radiation source to the detector for each of the plurality of positions.

5. The system of claim 3, wherein the processor receives the signal data and the position data while the first boom moves with respect to the cargo.

6. The system of claim 5, wherein the processor is configured to process the signal data and position data to construct a tomographic image of the at least a portion of the cargo.

7. The system of claim 6, wherein the processor receives the signal data and the position data for multiple positions of the mobile platform with respect to the cargo for constructing the image.

8. The system of claim 6, wherein the image is representative of a spatial distribution of density, X-ray or gamma-ray stopping power, of effective atomic number of concealed contents within the at least a portion of the cargo.

9. The system of claim 6, wherein the image is truncated or constructed from a truncated set of signal data obtained from the at least one portion of the cargo.

10. The system of claim 6, wherein the construction of the image utilizes algebraic, iterative, and/or approximation techniques.

11. The system of claim 6, wherein the at least a portion of the cargo comprises a portion of the cargo identified as a region of interest from a previous inspection of the cargo.

12. The system of claim 2, wherein the detector comprises a linear or two-dimensional array of detectors.

13. The system of claim 12, wherein the linear array or the one two-dimensional array is configured in an L shape, a curved shape, or a portion of a polygon.

14. The system of claim 2, wherein the radiation source comprises at least one X-ray or at least one gamma-ray source.

15. The system of claim 1, further comprising:
a second boom, wherein the first and second booms are configured to position a plurality of the detectors in fixed positions with respect to the mobile platform for detecting radiation from the radiation source; and
a processor configured to receive signal data representative of radiation detected by the plurality of detectors.

16. The system of claim 15, wherein the sensing apparatus is configured to provide position data for determining positions of each of the plurality of detectors and the radiation source with respect to the cargo.

17. The system of claim 16, further comprising motion control apparatus configured to direct radiation from the radiation source to each of the plurality of detectors.

18. The system of claim 16, wherein the processor receives the signal data and the position data while the first and second booms move with respect to the cargo.

19. The system of claim 18, wherein the processor is configured to process the signal data and position data to construct a tomographic image of the at least a portion of the cargo.

20. The system of claim 19, wherein the processor receives the signal data and the position data for multiple positions of the mobile platform with respect to the cargo for constructing the image.

21. The system of claim 19, wherein the image is representative of a spatial distribution of density, X-ray or gamma-ray stopping power, of effective atomic number of concealed contents within the at least a portion of the cargo.

22. The system of claim 19, wherein the image is truncated or constructed from a truncated set of signal data obtained from the at least one portion of the cargo.

23. The system of claim 19, wherein the construction of the image utilizes algebraic, iterative, and/or approximation techniques.

24. The system of claim 19, wherein the at least a portion of the cargo comprises a portion of the cargo identified as a region of interest from a previous inspection of the cargo.

25. The system of claim 15, wherein the plurality of detectors include a linear or two-dimensional array of detectors.

26. The system of claim 25, wherein the linear array or the one two-dimensional array is configured in an L shape, a curved shape, or a portion of a polygon.

27. The system of claim 15, wherein the radiation source comprises at least one X-ray or at least one gamma-ray source.

28. The system of claim 1, wherein the mobile platform comprises a truck and the boom is articulated and/or retractable.

29. A method for inspecting cargo comprising:
emitting penetrating radiation from at least one source on a mobile platform;
positioning a detector connected to a boom attached to the mobile platform;
moving the boom and/or mobile platform with respect to the cargo;
detecting signals representative of radiation that passes through at least one portion of the cargo in more than one direction with the detector; and
constructing a tomographic image of at least a portion of the cargo from the detected signals.

30. The method of claim 29, wherein the moving comprises swinging the boom in steady motion with respect to the mobile platform.

31. The method of claim 29, wherein the moving comprises moving the boom to a plurality of distinct locations in step-like motion.

32. The method of claim 29, wherein the moving comprises moving the mobile platform with respect to the cargo in steady motion.

33. The method of claim 29, wherein the moving comprises moving the mobile platform to distinct location with respect to the cargo in step-like motion.

34. The method of claim 29, further comprising receiving, by a processor, data representative of the detected signals while the boom and/or mobile platform moves with respect to the cargo.

35. The method of claim 34, further comprising receiving, by the processor, motion and/or position data from at least one sensor for determining positions of the detector and the radiation source with respect to the at least a portion of the cargo.

36. The method of claim 35, further comprising calculating, by the processor, at least one location of the detector and the source with respect to the at least a portion of the cargo based upon the motion and/or position data.

37. The method of claim 29, wherein the image is representative of a spatial distribution of density, X-ray or gamma-ray stopping power, of effective atomic number of concealed contents within the at least a portion of the cargo.

38. The method of claim 37, wherein the image represents a two-dimensional or three-dimensional distribution of the concealed contents.

39. The method of claim 37, wherein the image is truncated or constructed from a truncated set of the detected signals.

40. The method of claim 29, wherein the constructing comprises using algebraic, iterative, and/or approximation techniques for constructing the at least one image.

41. The method of claim 29, further comprising selecting the at least a portion of the cargo based upon a previous inspection of the cargo.
